(19) United States
(12) Patent Application Publication
(10) Pub. No.: US 2008/0174226 A1
(43) Pub. Date: Jul. 24, 2008

(54) Mercury-free flat fluorescent lamps

(75) Inventors: Lyuji Ozawa, Poughkeepsie, NY (US); Chun-Hui Tsai, Tainan (TW)

Correspondence Address: BIRCH STEWART KOLASCH & BIRCH, PO BOX 747, FALLS CHURCH, VA, 22040-0747, US

(73) Assignees: NULIGHT TECHNOLOGY CORPORATION; CHI-MEI CORPORATION

(21) Appl. No.: 11/656,484

(22) Filed: Jan. 23, 2007

(51) Int. Cl. H01J 1/62

(52) U.S. Cl. 313/485

(57) ABSTRACT

The present invention relates to a mercury-free flat fluorescent lamp, which is comprised with two separated electric circuits in electron flow that are a driving electric circuit on a base plate glass and an internal electric circuit formed in a Xe chamber. The internal electric circuit receives the electric energy from the driving electric circuit by means of the surface-bound-charges that form with polarized charges in surface volume of insulator particles and the ionized Xe⁺ and e⁻ charges in the Xe chamber, which are induced by the alternated electric field from electrodes in the driving electric circuit. The internal electric circuit has electron flow between separately accumulated charges of Xe⁺ and e⁻ on the insulator particles in the Xe chamber; and Xe discharge is generated by the moving electrons in the Xe chamber. Phosphor screens coated on inner wall of the Xe chamber emit photoluminescence under irradiation of the vacuum ultraviolet lights emitted from Xe discharge in the Xe chamber. By optimization of the individual items involved in operation, a practical mercury-free flat fluorescent lamp has been invented.

### FIELD OF THE INVENTION

The present invention relates to a mercury-free flat fluorescent lamp (FFL), which emit photoluminescence (PL) from phosphor screen coated on inner surface of flat glass plates in the vacuum vessel, in which the phosphor screen is irradiated by the vacuum ultraviolet lights emitted from discharge in the Xe chamber; more precisely relates to said phosphor screens comprised phosphor particles capable to lessen initial ignition potential, maintaining potential, long ignition delay in dark, and resistance of mobile electrons in front of phosphor screens in the Xe chamber; and relates to the phosphor screens capable of elimination of flickering of Xe discharge; and to shortening gap between discharge path and phosphor screen for increase in ultraviolet light intensities reached on phosphor screen, and furthermore relates to reduction of operation power of flat fluorescent lamp by application of line scanning mode for driving of the lamp.

### BACKGROUND OF THE INVENTION

Human, who are diurnal habit for 7 million years, have significantly extended their activity to dark by invention of light sources, which have started from fire of woods, flaming torch, burning of oil, candles, and gases as candescent light sources, and after discovery of electrons, bulbs of tungsten filament lamps, tubular fluorescent lamps (FL), high-brightness-light emitting-diode (HBLED) with combination of phosphor particles, and thin film plates of inorganic and organic electroluminescent devices (EL and OLEL, respective) as incandescent light sources. Tungsten lamps and HBLEDs are point light sources, like as the sun light, that generate dark shadow of objects. The human eyes have adjusted to the wild scenery under lightly overcastted sky (e.g., plane light source) for 7 million years, so that the human eyes comfortably watch objects under the plane illumination, like as the wild scenery in the daytime. The scenery under direct sun-lights, like as scenery in desert, is too bright for the eyes, and the eyes are permanently damaged by the observation of brighter scenery for a long hour. There is a suitable illumination level under the plane illumination. The lights are the particles having the energy. According to the article of Chemical Review, Vol. 103, No. 10, pp 3835 to 3855, 2003, (hereinafter reference A), the wild scenery under the lightly overcastted sky is made by about 10²¹ photons per cm² second. The plane illumination should response on the requirements. The developed incandescent light sources are covered with the plate and film which scatter the lights, like as cloud for sun lights. However, we do not yet have the comfortable plane light source, due to the insufficient light sources. The criteria of the selections of the appropriate incandescent light sources, which have been developed, are below:

The energy conversion efficiencies (energy of out-put lights per input energy) of tungsten lamps is 0.8%, and the lamps holds it up to about 3000° C., just below melting temperature of tungsten filament (3422° C.). Since tungsten lamps give the various levels of luminance by change of heating temperature of tungsten filaments, and since the production cost is a lowest level, tungsten lamps are widely used as the illumination source in living rooms in house, offices, stores, and outdoors for a century. The disadvantage of the tungsten lamps is heated temperature and power hungry as light source.

Recently, HBLEDs absorb an attention as the new light source, which is expected for substitution of tungsten lamps. Lights from HBLEDs are generated by recombination of injected electrons at the recombination centers of electrons and holes in thin films. Quantum efficiency (number of emitted photons per the number of injected electrons) of HBLEDs is around 50%. The energy of 50% of the injected electrons to the thin films converts to the light, and residual 50% of the energy of the injected electrons converts to heat. For example, a HBLED in the practical use is operated by 60 A/cm² sec with 5 V. The electric current of 1A contains 0.6×10¹⁹ electrons. The operated HBLED emits about 4×10²⁰ photons/cm² sec that are suitable photons as a light source. The problem of the operating HBLED is heat-up HBLED to high temperatures about 200° C. by the energy of 150 W/cm² (=60×0.5×5 W/cm²). HBLED is constructed with thin films with dopants which form luminescent centers. Dopants in the thin films are impurities for the crystals and the impurities slowly diffuse out from the thin films heated at 200° C., resulting in the decrease in the light output from HBLED. The lifetime of the practical operation is a serious problem of HBLED usage. The calculations show that EL and OLEL have the similar stories with HBLEDs, as the devices are operated at a high luminance.

FL utilizes the discharge of vaporized Hg of which the number is determined by the temperature of heated tubular FL. It is around 40° C. that gives the Hg vapor in a low pressure. The discharge of Hg vapor in the low pressure belongs to a corona discharge. Since a large amount of excited Hg vapor in corona discharge can be made by two dimensional extensions (longitudinal length) of the discharge, FL is usually made by tubular glass, instead of point light source. The Hg vapor in corona discharge emits a very strong ultraviolet (UV) light at 254 nm, accompanying the many line-like lights in the visible wavelengths. The phosphor screens, which are coated on surface of inner wall of tubular glass, transduce the strong intensity of the 254 nm UV lights to the lights in the visible wavelengths. The emitted lights are photoluminescence (PL). Output of PL (PLₒᵤₜ) from FL is given by

PLₒᵤₜ=∫Iₒ ds dt (1)

wherein s is area of phosphor screen, I₀ is luminance, and t is time. For a given FL, I₀ and t is usually constant, and s is variable. According to Eq (1), PL output directly proportionate to s of FL. Therefore, FL is made by tubular glass in a large diameter (e.g., about 3 to 5 cm) for illumination purpose for last 50 years. Hg at room temperature is liquid phase. Hg must vaporize for discharge in FL lamp. Vaporization of Hg is achieved by addition of the auxiliary argon (Ar) gas. Temperature of corona discharge of Ar gas in 10 mmHg heats up Hg to evaporation (evaporation temperature T_{b}=357° C.). Ar gas does not emit the strong UV lights. The energy conversion efficiency of commercial FL is about 20%. With the high energy conversion efficiency and low production cost, FLs are popular in a modem life activity as well as the save of the energy for the environmental protection. FL provides a good scattered light source with tiny phosphor particles.

Phosphor screen in FL is constructed by arrangement of phosphor particles in a few microns (μm), and phosphor particles are transparent in the visible lights, giving rise to the white body color. Beside the particle sizes, the practical phosphor particles (by reference A) are the crystals that have center of asymmetry. The asymmetrical crystals have the large dielectric constant ε which relates to the index of refraction n (ε=n²). The commercial phosphor powders have the high dielectric constants (ε≈6 to 10) that are around n=2.5. Therefore, about one third of the lights {(n−1)/(n+1} reflect on inside and outside boundaries of phosphor particles. Phosphor screen itself acts as a good scattering material of visible lights.

A problem of FL is tubular light source, and it is not plane light source. A plane light source has made by parallel arrangement of plural tubular FLs with a light scattering cover. This is an inconvenience in practice. Another problem of FL is the saturation of PL output with input power, due to self-absorption by unexcited Hg vapors between discharge column and phosphor screen. The diameter of corona discharge column shrinks as input power increases, so that the number of un-excited Hg vapors between phosphor screen and discharge column increases with the input power. As already described, PL output from phosphor screens is linear with the UV light intensities on phosphor screen in a quite wide range. Although the number of generated UV photons from tubular FL is increased with the input power, the number of the UV photons reached on phosphor screen is a constant. This gives apparent saturation of PL output from tubular FL with the input power.

The space between corona discharge column and phosphor screen is shortened by the reduction of the diameter of tubular glass. The PL output from FL indeed increases as the diameter of tubular glass of FL is narrowed. However, the ignition voltage for the discharge of Ar gas markedly increases; destroying the cathode filaments by bombardment of the accelerated and energized Hg⁺ and Ar⁺ ions by the high applied voltage. The damage of the filament cathodes is solved by application of the metal (cold) cathodes to the narrowed tubular FL that is cold cathode fluorescent lamps, CCFL. Operation of CCFL requires a high threshold voltage for the ignition of the corona discharge, several kV that requires a large volume of operation devices and cost. The difficulty is practically solved by application of a piezoelectric transformer in a tiny size. By application of the piezoelectric transformer, the inner diameter of CCFL narrows to 1 cm and further 1 to 2 mm. The Ar gas pressure increases to around 50 torr for an increase in CCFL glass temperature; resulting in a high 254 nm UV light intensity. CCFL in narrower tube has high Ar pressure. Basics of PL generation, the combinations of discharged UV lights and phosphor screens have been well studied by developments of FL and CCFL.

A flat light source is realized by a combination with the CCFL and light scattering plate. The flat light source by CCFL is widely used as the backlight of liquid crystal display (LCD) devices. The maximum brightness of CCFL flat light source is limited by the heated temperature of the tubular glass, and power consumption. Another disadvantage of CCFL is the narrow diameter that is a fragile for handle. The disadvantages of CCFL limit the application area to LCD backlights, even though the brighter plane light source can be made by the arrangement of the plural CCFLs with a high cost. A development of a practical FFL, which has flatness with a low heating temperature, low power consumption, easiness of handling, and low production cost, is waiting for a realization for last 30 years. Furthermore, the developed FFL must be Hg free which is restricted by the environmental protection. Therefore, we must take out the Hg in the development of FFL. The development of a practical FFL is urgent task in our modem life.

It is well known in early time of vacuum science on 19^{th} and 20^{th} centuries that H, He, N, O gasses and the rare gases (Ne, Ar, Kr, Xe and Rn) in low pressure discharge in a sealed vacuum glass vessel, as the gases are under electromagnetic field in high frequencies, e.g., KHz. Gas discharge lamp by glass bulb had demonstrated by N. Tesla on 1893. Electromagnetic field can apply to gases in vacuum glass vessel from the electrode placed at outside of glass tube. Glass is dielectric material. H, He, N and O discharges have no strong UV lights. Kr and Rn are too expensive gases for the FFL. The practical gases are limited to Xe, Ne, and Ar. Among them, Ne and Ar have the discharge the lights in the visible wavelengths and they do not emit the strong UV discharge lights. Xe gas in high pressure has arc discharge and the discharged Xe gas emits the strong white lights at high temperatures. Only Xe gas in a low pressure emits the strong UV lights at 147 nm and 172 nm, which are the vacuum ultraviolet lights (VUV), with a less heating temperature of the used vacuum vessel. The discharge of Xe gas in the low pressure belongs to the corona discharge. As the metal electrodes of anode and cathode mount in the Xe gas chamber, the threshold voltage of the discharge of Xe gas is very high (more than 7 kV) with the dc supply. The threshold discharge voltage is remarkably lowered to a few kV under the alternating sinusoidal voltages in the high frequencies. The discharge in the high frequency field is limited to the propagation distance of the electromagnetic field to a short distance, e.g., a few mm to cm. Therefore, a longitudinal discharge path (tubular FL) is not expected by Xe discharge.

There are many reports of the discharge of Xe gas in the short distances in order to aim the practical applications in last 30 years. For instance, there are the commercialized plasma display devices (PDP) and a development of FFL, using PL from phosphor screen irradiated by 147 nm and 172 nm VUV lights. PDP utilizes Xe discharge between the small metal electrodes (sizes equal with image pixel in mm) which are installed on inside of basic glass plate of the flat glass vessel, and phosphor screens are coated on inside surface of top flat glass plate. In PDP devices, Xe gas discharges between the metal electrodes, which have the complicated structures for reduce of the discharge voltages to around 500 V It has empirically found that if surface between the electrodes of the basic glass plate is covered with MgO thin film, the threshold of the Xe discharge is remarkably lowered. It has been assumed that MgO has a large emission ratio of secondary electrons to the input electrons, and that the surface on the MgO film has many free electrons. According to their hypothesis, the free electrons on MgO thin film smoothly move toward to the anode, and they are efficiently accelerated by the anode field. The accelerated electrons collide with Xe gas to ionization, resulting in discharge of Xe gas. Here arises a practical difficulty that MgO film does not always have the surface conduction; surface conduction is sometime a high and other times are a low. The formation of MgO thin film, which has the surface conduction, has a poor reproducibility. Furthermore, MgO has a highest melting temperature (Tₘ=2825° C., as compared with Tₘ=2054° C. for Al₂O₃, and Tₘ=1470° C. for SiO₂) on the earth. Therefore, the production of MgO thin film on substrate is a hard work, resulting in the cost-up of PDP production. Beside the MgO film, the high tolerance requires in the PDP production for assembling of electrodes and formation of phosphor screens on the surface of the rib structure. Although the excitation of phosphor screens in FFL is the same with the PDP, that is the VUV lights from Xe discarge, the high tolerances of the production are not practical to the development of a FFL with the high production cost. The production cost should compete with the production cost of CCFL and FL, which have low production cost. The production of FFL requires a simple structure for the Xe discharge and phosphor screens, which promise an inexpensive production cost for the acceptance by the consumer use.

According to U.S. Pat. No. 5,006,758, Gellert et al., it makes a possible that a discharge of Xe gas can be made in a small space on the glass layer which is defined by the electrodes 5 and 6 in the melted frit glass layer 7 arranges in the vacuum vessel 1 in FIG. 1. The disclosure provides us a much simple structure of the electrodes for the production of the Xe discharge in the vacuum chamber, as compared with the electrodes of PDP. It should be noted that as already described, the principal of discharge of Xe gas by electromagnetic field through glass layer is well known from the early vacuum science. A typical example is the gas discharge in glass tube by Tesla coil. Mikoshiba has reported that if the tube is wind up coil and if the coil is operated in high frequencies, Xe gas in glass tube discharges. According to U.S. Pat. No. 5,006,758, electrodes are made by print technique of silver (Ag) paste on inside surface of the basic glass plate. After dry of the Ag paste, the Ag electrodes are simply covered with the slurry of a frit glass. The frit glass melts down by a heat around 450° C. to 550° C. Ag electrodes must be completely covered by the melted frit glass. Thick frit glass layer is the same of glass vessel. There is an appropriate thickness for FFL. U.S. Pat. No. 7,148,626 discloses the thickness between 0.3 mm to 1.1 mm.

FIG. 1(A) and FIG. 1(B) explains the empirically found discharge of Xe gas 20 in FFL. Since the Xe gas 20 does not directly contact with the metal electrodes (anode 5 and cathode 6), the Xe gas 20 in the vacuum chamber 1 does not discharge by application of direct current (DC) potential, even with the high anode potential (e.g., 10 kV), as illustrated in FIG. 1(A). As alternating potential in high frequencies (>15 kHz) is applied to the pair electrodes (anode 5 and cathode 6), the Xe gas in the chamber locally discharges in the space, corresponding to the defined space between the embedded electrodes in different polarities, as illustrated in FIG. 1(B). This phenomenon has been founded on the late 19 century, as already mentioned. The VUV lights from the discharge irradiate on the phosphor screens 8, which are coated on surface of the interior walls of top 3 and on surface of frit glass layer 7 on the basic glass plates 2 of the vacuum vessel 1. The pairs of the discharge electrodes in the small sizes are discontinuously arranged on the basic glass plate; consequently, the PL incoherently emits on the phosphor screens in FFL. A flat FL, which is composed by many incoherent PL areas, but PL is scattered widely, is produced by the arrangement of many pairs of the embedded strip-like electrodes on the basic glass plate.

There is no electron flow through the frit glass layer 7 (hereinafter insulator 7) to the Xe chamber in which fill Xe gas. Nevertheless the discharge mechanism of Xe gas, which is isolated from the electrodes 5 and 6 by the insulator, remains uncleanness in the publications; the study of the FFL has been moved forward to the inventions based on the empirical findings. U.S. Pat. No. 5,604,410 discloses a simpler configuration of the electrodes for the production of the Xe gas lamp bulb, by the arrangement of the anode electrode on outer surface of the glass of the vacuum chamber and the cathode metal electrodes at center of the vacuum vessel. The inventors of the present invention have analyzed the discharge data of U.S. Pat. No. 5,604,410, Vollkommer et al., and then the inventors of the present invention have found that the disclosure is not directly related to FFL, but the disclosure describes an important finding that is the operation of the Xe discharge between the anode electrode on outside of the vacuum vessel and the cathode metal electrode in the vacuum vessel. The delta-shaped discharge pattern, that top is the anode and bottom is the cathode, is formed in their Xe-lamps, indicating that the discharge of the Xe gas in the lamp between the space on the anode and the space of the cathode. Their results can be summarized as FIG. 2 that schematically illustrates configuration of electrodes 5 and 6 embedded in insulator 7 and Xe discharge direction in vacuum chamber. The observation of the electron flow is the important finding for analysis of the Xe gas discharges in the FFL, but the inventors of U.S. Pat. No. 5,604,410 do not be aware of their considerable results.

U.S. Pat. No. 5,604,410 have empirically found the appropriate waveform of which is applied to the electrodes 5 and 6 of the driving electric circuit. The pulse voltage, rather than the sinusoidal alternating voltage, applies to the electrodes for the rapid start of the discharge. A best performance is obtained with the pulse that consists of two parts of the duration; initial spike duration tₛ with Vₚ and idling duration tᵢ with Vᵢ. The value of tₛ is defined as the time of the half of the peak potential Vₚ. The discharge of Xe-gas starts by application of Vₚ, and then the discharge follows for the idling duration with Vᵢ. The typical pulse is composed by tₛ=1.2 μs and tᵢ=37.5 μs. By application of a negative spike potential of 4 kV to the cathode against the anode of ground, the VUV light intensity is optimized by the pulse frequencies of 25 kHz. The phosphor powders, which are similar with the phosphors for CCFL, are used to the phosphor screens, which are coated on inner wall of the vacuum chamber. They are BaMgAl₁₀O₁₇:Eu²⁺ (BAM) as the blue PL, Y₂SiO₅:Tb³⁺ as the green, and Y₂O₃:Eu³⁺ as the red.

U.S. Pat. No. 5,994,849, Vollkommer et al., discloses the FFL by arrangement of the stripe-like electrodes of the both anode and cathode on the outside of the basic glass plate of the flat vacuum vessel. The FFL in the large sizes is for the backlight of liquid crystal display (LCD), and the FFL is operated by the application of the pulsive potential to the electrodes.

U.S. Pat. No. 6,034,470, Vollkommer et al., discloses the electrodes placed in the vacuum vessels, and the electrodes are completely covered with the melted thin frit glass. The thin melted frit glass has many pinholes. When the frit glass on the electrodes has pinhole, the electrode does not work. The stripes of the cathode have many nose-like extensions for the improvement of the ignition delay after application of the voltage to the electrodes. The phosphor screen coated on inner walls of the vacuum vessel is composed by BaMgAl₁₀O₁₇:Eu²⁺ as blue, LaPO₄:Ce³⁺:Tb³⁺ (LAP) as green, and (Y,Gd)₂O₃:Eu³⁺ as red. For an increase in PL output from phosphor screens, a layer of Al₂O₃ and/or MgO, as the light reflector, inserts between phosphor screen and the base plate. As already described, layers of phosphor particles are excellent light reflector.

EP-A 0 363 832, Vollkommer et al., discloses that the ignition voltage Vₚ of FFL is further lowered as the light reflecting layer has a high δ values of secondary electron ratios. Such materials are MgO, Yb₂O₃, La₂O₃, and Ce₂O₃. As phosphor screen coats on the layer of those materials, according to their assumption, the phosphor layer on the reflecting layer markedly obstructs the emission of the secondary electrons, increase Vₚ of Xe gas. U.S. Pat. No. 6,984,930, Döll, discloses the lowering of Vₚ by the partial removal of the phosphor screen on the reflection layer, corresponding to the area between the electrodes.

Although there are many other issued patents and published articles on the development of the FFL, the basics of the claims are covered by the descriptions above. However, a practical FFL is still not produced by the issued patents and publications, indicating that something else is overlooked in the development of the FFL. The FFL, which is capable of brighter PL, low power consumption, and a simple structure promising low production cost, is required now.

### SUMMARY OF THE INVENTION

The inventors of the present invention have studied to solve the above described problems for the development of the practical FFL. As the results of the study, the inventors of the present invention have found that the indistinctness of outline of basics of Xe discharge involved in operation of FFL relates to two separated electric circuits. They are (a) driving electric circuit which is directly connected with driving electrodes of outside of the Xe chamber, and (b) internal electric circuit formed in the Xe chamber. Two electric circuits are independent in the electron flow each other.

Within a limitation of our knowledge, no discussion has so far made about internal electric circuit of FFL. Before description of the present invention, therefore, the inventors of the present invention like to give the definition of the driving electric circuit and the internal electric circuit of FFL. FIG. 3(A) illustrates fundamentals of the driving electric circuit between the electrodes embedded in an insulator layer 7 on a basic glass plate 2 of FFL. The equivalent circuit of FIG. 3(A) can be expressed by FIG. 3(B) comprising with a power source 9, a condenser 10, an insulator 7, and a pair of electrodes 5 and 6. The equivalent circuit in FIG. 3(B) is defined as the driving electric circuit in this disclosure.

The internal electric circuit is formed in the Xe chamber as following conditions are fulfilled: the polarized charges on surface volume (hereinafter SV) of insulator 7 have an important role for formation of the sad internal electric circuit in the Xe chamber. The polarized charges are also generated in entire volume of the insulator 7 with distribution. Most strong strength of polarization is in normal direction on the electrodes. FIG. 4 illustrates the polarized charges on internal boundary of the insulator 7. The polarities of charges at the internal boundary of the insulator 7 correspond to the polarities of the electrodes 5 and 6, respectively. Each polarized charge at SV of the insulator 7 extends their electric field to the Xe chamber. The outside of the insulator 7 expose on Xe gas. Xe gas is electrically neutral gas so that Xe gas do not interact with the polarized charges in SV of the insulator 7. When the electrodes have extremely high dc V; e.g., above 20 kV, the Xe gas in the Xe chamber is ionized. Ionized Xe gas (Xe¹⁺ and e⁻) have electric charges that interact with the electric field of the polarized charges in SV of the insulator 7.20 kV DC potential is too high for the practical FFL. When the applied V are modified by high frequencies, e.g., above 30 kHz, Xe gas in the Xe chamber are surely ionized with a lower anode voltage, e.g., a few kV. Xe¹⁺ and e⁻ are separately attracted by the polarized charges, and are bound on surfaces of polarized the insulator 7. As the amount of the separately bound Xe¹⁺ on the insulator surface is high, the bound Xe¹⁺ has a high positive potential. The bound Xe¹⁺ in the high positive potential may extract electrons from the bound electrons. The extracted electrons move to the bound Xe¹⁺ in front of the phosphor surface in the Xe chamber. In moving process, moving electrons are accelerated, and accelerated electrons collide with Xe gas to generate Xe discharge. Finally the moving electrons reach on Xe¹⁺ and diminish from the Xe chamber. FIG. 5 illustrates discharge direction in the Xe chamber. It should note that according to the textbook of the solid-state, the direction of electron flow in vacuum, liquid, and solid is from cathode to anode. If one take care the polarities of the electrodes 5 and 6 in the driving electric circuit, the electron flow direction, corresponding to Xe discharge direction, is opposite direction. If one considers the bound charges, the Xe discharge in FIG. 5 is the right direction. The discharge process described above occur during one waveform of electric field in the closed space without electron flow from the insulator and electrodes in the driving electric circuit. In the practical FFL operation, the discharge processes are repeatedly with the cycles. This is the internal electric circuit comprising of power supply 11, switch 12 and resistance 13 shown in FIG. 6. It is obvious that there is no electron flow between the driving electric circuit and the internal electric circuit, but the electric energy surely transfers from the driving electric circuit to the internal electric circuit in the Xe chamber by means of (a) polarization of the insulator by electric field E (=V/r wherein r is distance from the electrode) of the electrodes 5 and 6 (as necessary condition) and (b) ionization of Xe gases by E of the electrodes 5 and 6 (as sufficient condition). Analogous of the energy transfer mechanism can find in organic chemistry. The energy transfer from the polarized catalytic insulator to surrounding solution has been well studied in catalytic activity of synthesis and cracking of organic materials. In our case, the surrounding media is the gas phase. What is happened in gas phase? The Xe discharge is generated in the Xe chamber by moving electrons between the bound charges in different polarities. The inventors of the present invention have found a way that is the increase in the polarization charges, which are formed in the surface volume of the insulator particles in the Xe chamber. The insulator particles in the Xe chamber are polarized by E of the electrodes 5 and 6 of the driving electric circuit. The polarization charges further increase by application of piezoelectric particles in the Xe chamber.

For optimization of Xe discharge in the Xe chamber, electric resistance 13 of moving electrons in FIG. 6(B) should minimize in the Xe chamber. The resistances of moving electrons in the Xe chamber are (1) collision with Xe gas, and (2) obstruction of electron movement in the path. The collision with Xe gas can be controlled by the Xe gas pressure. The inventors of the present invention have found a source of the obstruction of the electron path. The electrons move on in front of phosphor screens comprising of layers of the phosphor particles. The commercial phosphor particles are deliberately contaminated by the surface treatment with adhesion of microclusters that are the insulators. The contaminated phosphor particles have been overlooked in the study of the phosphor screens in FFL and FL. Furthermore, inner wall of FFL vessel is covered with many other insulator particles like as Al₂O₃, MgO, and other insulator particles. In FFL operation, those particles are polarized by E from the electrodes, and the particles also expose on Xe¹⁺ and e⁻ as the consequence of ionization by E. The Xe¹⁺ and e⁻ are tightly bound with the polarized charges in SV of the insulator particles. The tightly bound charges are the surface-bound-charge (hereinafter SBC). The inventors of the present invention have found that the commercial phosphor particles are electrically shielded by the SBC. The electric field of the SBC obstructs the electron path on the phosphor screen, giving rise to the discharge in rainbow shape, flicker, and brighter fringes with large dark area in center. By application of the phosphor particles which have a clean surface, SBC are completely taken away from the phosphor screen, resulting in straightened electron path in the Xe discharge process. The straightened electron path is in front of surface of the phosphor screen, resulting in minimum gap between discharge path and the phosphor screen. Consequently, self-absorption by Xe in the gap is minimized in FFL. Consequently, the VUV light intensities on the phosphor screens are increased, resulting in the remarkable increase in PL output from the phosphor.

All of the remained practical problems of (1) the high initial spike voltage Vₚ, (2) the maintaining voltage Vₘ, (3) a long ignition delay in dark have been taken away from the invented FFL, by application of cathodoluminescent phosphor powders and triboluminescent phosphor powders to phosphor screens.

The inventors of the present invention have found that no ignition delay of the Xe discharge allows line scan of FFL operation. Although the screen is scanned by horizontal lines per frame cycles, the eyes do not perceive the scanning lines, but the eyes perceive uniformly emitted screen by the effort of the afterimages of the eyes. Consequently, the power consumption of FFL can be reduced with the ratio of emitting area of line Sₗᵢₙₑ to total screen area S, e.g., Sₗᵢₙₑ/S. If Sₗᵢₙₑ is 0.1 of S, the power consumption of the FFL operation is 0.1 of frame scan. The line scan of FFL is a great advantage over CCFL and FL light sources. The power saving of the invented FFL is another advantage as backlight of LCD application, as well as lighting source for illumination of rooms.

Furthermore, as the invented FFL is applied as backlight of LCD, the black level of the LCD screen becomes a real black, like as the charcoal black, giving rise to the clear video images on LCD screen with high contrast ratio from the real black. Another advantage is that the response time of the images on LCD screen is actually determined by the response time of the backlight, independent on the response time of LC layer. This gives sharp images, not smeared images, on LCD screen. The color images on LCD screen likes as printed color images on sheets of graphic paper. Described features protect the human eyes from the permanent damage by watching of the natural images on LCD screens.

### BRIEF DESCRIPTION OF THE DRAWING

Embodiments of the present invention will now be described by way of examples and with reference to the accompanying drawings, in which:

FIG. 1(A) and FIG. 1(B) are partial of cross sections view of the developed flat fluorescent lamps,

FIG. 2 is a partial cross-section view of the electrodes on the basic glass plate of flat fluorescent lamp,

FIG. 3(A) and FIG. 3(B) are is driving potential of single cycle applied to a pair of the electrodes of flat fluorescent lamp,

FIG. 4 is cross-section of a pair of the electrodes on the basic glass plate of flat fluorescent lamp and equivalent the driving electric circuit,

FIG. 5 is cross-section of a pair of the electrodes embedded in the insulator on the basic glass plate which has polarized charges in the insulator layer by field of the electrodes, and which ionized Xe¹⁺ and e⁻ in Xe chamber bind with polarized counter charges in insulator in front of surface of the insulator,

FIG. 6(A) and FIG. 6(B) are schematic illustrations of direction of Xe discharge in Xe chamber,

FIG. 7 is schematic illustration of equivalent the driving electric circuit and the internal electric circuit in flat fluorescent lamp,

FIG. 8 is the wave form for ignition of Xe discharge,

FIG. 9(A) and FIG. 9(B) are schematic illustrations of polarized charges induced in the particles embedded the insulator layer and in particles placed in Xe chamber,

FIG. 10 is a partial cross-section of the phosphor screen between layers of the insulator particles on the insulator layer which is polarized by electric field from the electrodes, and Xe discharge path from accumulated electrons to accumulated Xe¹⁺ in front of the phosphor screen,

FIG. 11 is schematic illustration explaining surface-bound-electrons on surface of the polarized insulator,

FIG. 12 is a part of cross-section of the phosphor screen between layers of the insulator particles and layers of cathodoluminescent phosphor particles, which generate free electrons in Xe chamber in flat fluorescent lamp, the Xe discharge is made by attraction of free electrons by accumulated Xe¹⁺ charges,

FIG. 13 is a part of cross-section of cathodoluminescent phosphor screen and layers of the insulator particles, the free electrons are generated on cathodoluminescent phosphor screen, and Xe discharge in Xe chamber is made by moving electrons attracted by accumulated Xe¹⁺ charges,

FIG. 14(A), FIG. 14(B) and FIG. 14(C) are explanation of isotropic mobility of surface-bound-electrons (SBE),

FIG. 15 is phosphor screen, which are made on the polarized insulator, by triboluminescent and cathodoluminescent phosphor particles,

FIG. 16 is relative PL intensities of the phosphor screens in reflection mode and transmission mode, as a function of number of layers of the phosphor particles,

FIG. 17 is a part of the phosphor screens which are screened on inner wall of the base plate glass and the top plate glass of flat fluorescent lamp, and

FIG. 18 is schematic illustration of power saving of flat fluorescent lamp by line scan as compared with frame scan.

### DETAILED DESCRIPTION OF THE EMBODIMENTS AND EXAMPLES

Preferred embodiments of the present invention will now describe in details with reference to the accompanying drawings. In following description, a flat fluorescent lamp, FFL, will be explained as producer of photoluminescence as a consequence of conversion of vacuum ultraviolet (VUV) lights of Xe discharge to visible lights by operation of electrodes which are connected with driver device. Although the explanation is made by a single discharge unit, the practical FFL is comprised with many discharge units which are arranged on entire area of plane glass plate of FFL.

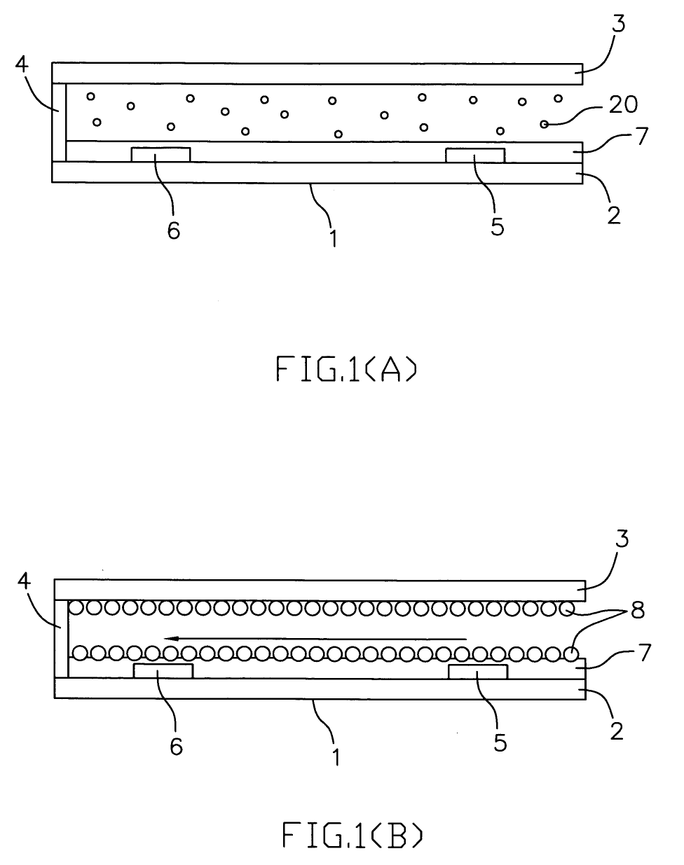

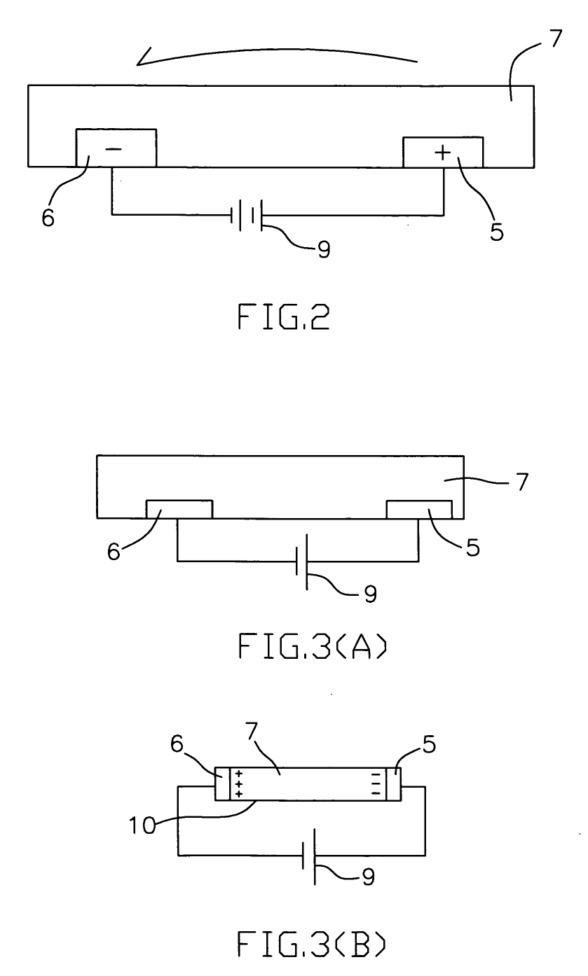

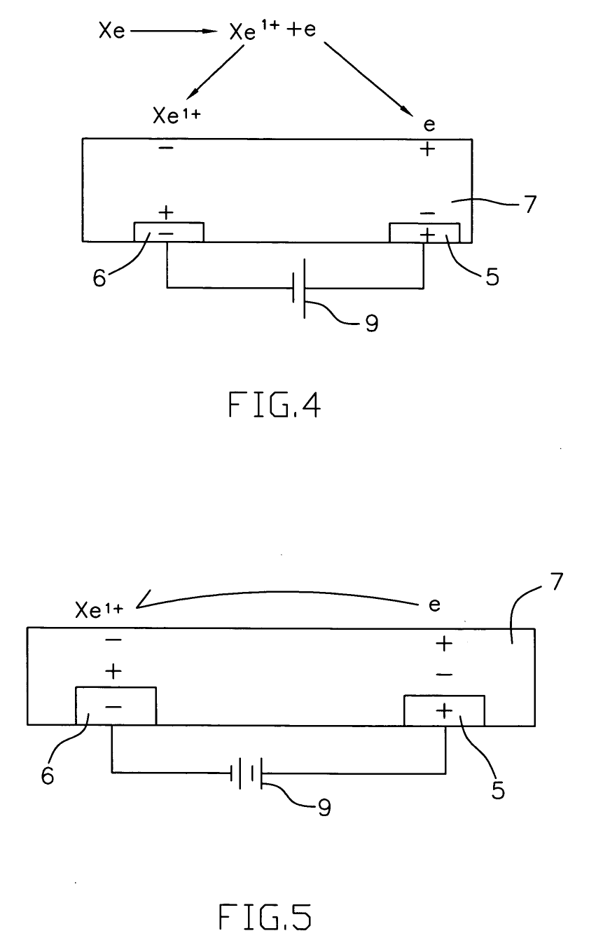

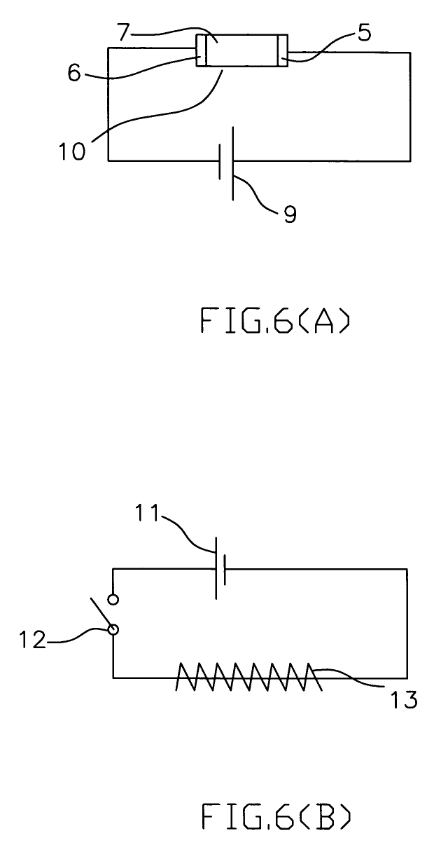

Although FFL shown in FIG. 1 is practically operated by attached electrodes 5 and 6 of a driving electric circuit on a basic glass plate 2, Xe gas in a Xe chamber is not directly connected with the electrodes 5 and 6 in electron flow. In FIG. 2 shows the electrodes 5 and 6 are covered with an insulator 7, which separates the driving electric circuit and the Xe chamber, electrically. Therefore, FFL is essentially composed two electric circuits in electron flow; the driving electric circuit [shown in FIG. 6(A)] on the basic glass plate 2 of FFL and an internal electric circuit [shown in FIG. 6(B)] in the Xe chamber in FFL. The FFL, which is operated by the driving electric circuits, have been well studied by many scientists and engineers with easiness of connections of wires of a power source and with easiness of measurements of signals. The present invention is not related to the driving electric circuit and to operation of the driving electric circuit. The present invention relates to formation of the internal electric circuit shown in FIG. 6(B), and optimization of individual items involved in the operations of the internal electric circuit. This subject has not yet studied by others.

As the electrodes 5 and 6, that are embedded in the insulator 7, are connected with a direct current (DC) power supply 9, the insulator 7 is under electric field E from the electrodes 5 and/or 6, and the lattice ions of the insulator 7 are deformed by E. Accordingly, the insulator 7 has orderly charges that are polarized charges of the insulator. The polarized charges in the insulator are apparent charges by the deformation of lattice ions by E, and the polarized charges can not take out from the practically used in many electronics elements. A typical usage of the polarized charges is a condenser. Condenser is formed between the electrodes 5 and 6 by the polarized charges in the insulator 7. Capacitance C of the condenser is given by amount of the polarized charges in the insulator volume between the electrodes, and C is expressed by C=εS/d, wherein ε is dielectric constant of the insulator, S is surface area of the electrodes faced on the insulator, and d is distance between the electrodes. ε, S, and d are constant for a given condenser. Magnitude of deformed lattice, corresponding to the polarized charges, is a linear function of applied E to the insulator. The polarized charges Q in the insulator between the electrodes is given by Q=kCV, wherein k is constant. Consequently Q changes with V to the driving electric circuit in FFL.

Driving conditions of the driving electric circuit are: The polarized charges in the insulator do not change the polarization direction under dc V, but they change the polarization directions under alternated current (AC) V at above the threshold frequencies. By the change of directions, induced current appears in the driving electric circuit, which is given by the impedance (Z) that is Z=jωC wherein j is imaginary constant (j²=−1) and ω is frequencies. Although there is induced current, according to Z in the driving electric circuit, electrons never pass through the insulator from the electrodes under AC E in high ω. Under AC E with high ω, direction of deformed lattice ions changes with frequencies. The change of the polarization direction is a kind of vibrations of lattice, generating heat. The heat of the insulator is not caused by collision of flowing electrons. It is vibration of lattice ions by the AC E. In practice, we have Xe discharge in the Xe chamber by operation of the driving electric circuit. The inventors of the present invention have found the energy transfer mechanisms from the driving electric circuit to the internal electric circuit. It is utilization of the polarized charges in the insulator which is under electric field E from the electrodes.

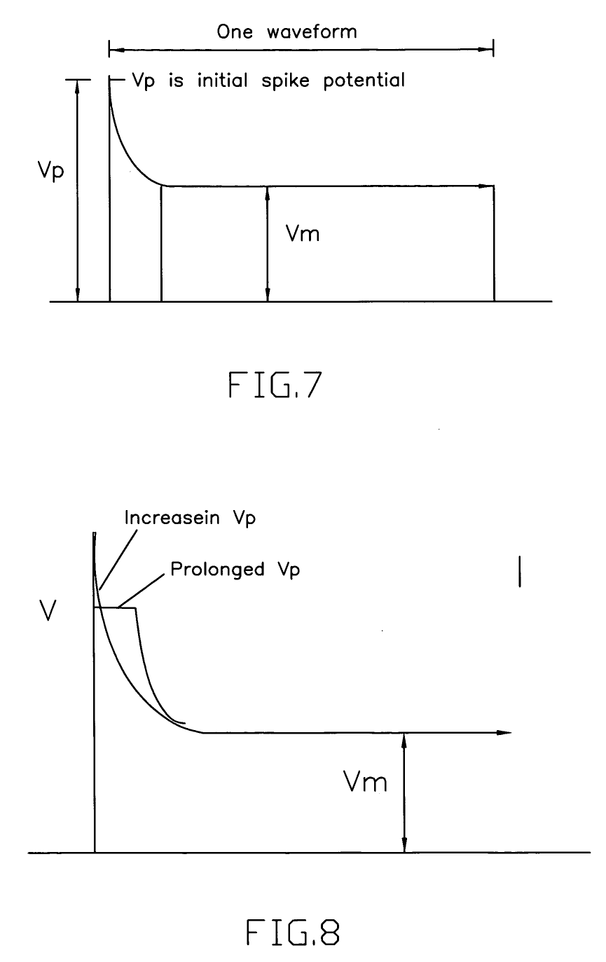

As already described in the above, the Xe chamber forms the internal electric circuit by which are triggered by polarization of the insulator 7 by E from the electrodes 5 and 6 (necessary conditions) and by ionization of Xe gas by E of the electrodes 5 and 6 (sufficient condition). When the potential V to the electrode 5 and 6 is not large enough for generation of the polarized charges in SV of the insulator 7, the amount of the formed Xe⁺ charges on the insulator 7 is small for extraction of the electrons from the SBE. Although the produced SBC on the insulator 7 during one cycle of alternated V is a small to generate the internal electric circuit, there is a way for accumulation of the SBC on the insulator 7 by repetition of E cycles. The binding force of the SBC with the counter partners is strong with a short distance between the SBC and the polarized charge (5 μm apart). The binding force of the electron with the hole F_{SBC}=e⁻/5×10⁴ cm (=e⁻2×10³/cm). The binding force of the electron by the electrode (1 mm apart) F_{electrode}=e⁻/1×10⁻¹ cm (=e⁻×10/cm). F_{SBC}/F_{electrode}=200. The binding force of SBC is 200 times stronger than binding force by the electric field from electrodes 5 and 6. Therefore, the SBC stay on the surface after change of the waveform of AC power. When the electrodes 5 and 6 have next cycle in the same polarity, E from the electrodes 5 and 6 generates new Xe¹⁺ and e⁻ in the Xe chamber. New charges in the Xe chamber add to the previously formed the SBC on the same place. By repetition of cycles, accumulation of Xe¹⁺ and e⁻ to the SBC on the insulator 7 continues until the SBC become the sufficient amount of X¹⁺ for extraction of electrons from the SBE. Accumulation period, which has been empirically observed as starting Xe discharge, is a few cycles to several cycles, depending on the potential used. The accumulation period has been expressed as delay of ignition of Xe discharge. Actually, it is the time for accumulation of the SBC on the insulator 7 for extraction of electrons from counter SBC. Amount of the polarized charges in SV of the insulator 7 is changed by E. Therefore, with the given the insulator 7, the ignition delay can be solved by increase in applied V to the electrodes 5 and 6. FIG. 7 shows schematic illustration of the waveform consisting of Vₚ and Vₘ that is maintaining voltage.

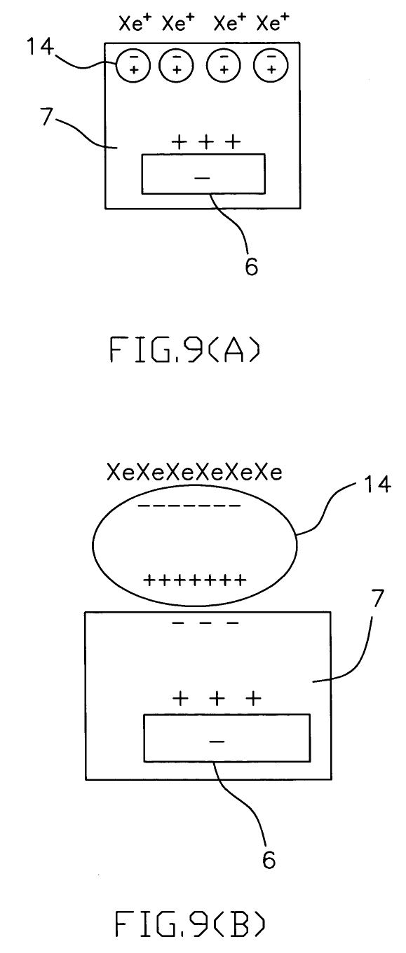

The formation of sufficient amount of the SBC is markedly influenced by the waveform and peak potential of AC power supply. The starting potential of the Xe discharge has been certainly reduced to a few kV range, by application of pulse cycle, rather than sinusoidal AC to the electrodes 5 and 6. A preferable waveform for starting discharge is not rectangular. The preferable waveform consists of two parts; initial spike potential Vₚ and maintaining potential Vₘ as illustrated in FIG. 7. The initial spike potential Vₚ indicates that the starting of Xe discharge in the Xe chamber instantly occurs by Vₚ, and different discharge mechanisms are involved in the following Xe discharge. We must consider two different mechanisms involve in Xe discharge in one waveform. If there is ignition delay with the given waveform, as already described, the ignition delay can be solved by increase in Vₚ and/or prolonging of the peak duration of Vₚ, as illustrated in FIG. 8, with sacrifice of the cost of the driving devices. The switching of the internal electric circuit is dependent on the accumulated charges, which can be changed by the combinations of Vₚ and number of cycles.

The large polarization is made by (1) high Vₚ under the given ε, and (2) large dielectric constant ε under the given Vₚ. As the practical display, Vₚ should be minimized for the cost of the driving device of FFL. In the FFL developed by others, the ε value of the insulator 7 is determined by the frit glass that has ε□4. When an insulator particle puts in the field E, the particle is polarized and amount of the polarized charges (P) proportional to ε value (P=εE). Therefore, a way of further increase in the ε value of the insulator 7 is an addition of some amount of the particles, having the ε values larger than ε=4, to the insulator 7. FIG. 9(A) illustrates the increase of the SBC (Xe¹⁺) on the insulator 7 which contain the additional insulator particles 14. The suitable particles for the addition to the insulator 7 are the particles which do not melt down at the melting temperature of the insulator 7, and which do not chemically react with the components of the insulator at the melting temperature of the insulator 7. Preferable materials are particles in the average sizes between 0.5 and 15 μm of oxide, aluminates, silicates, titanites, phosphates, and sulfides. By the addition of the particles in the insulator 7, the capacity of the condenser increases for operation of the driving electric circuit. This is not desired for practical FFL.

Further lowing of Vₚ, without increase in the capacity of the driving electric circuit, is achieved by the layers of one and/or combinations of above listed particles on the insulator 7. The particles are polarized by E, but the polarization of the particles is not directly involved in the driving electric circuit. The particles on the insulator 7 must be under the sufficient E from the electrodes 5 and 6. Therefore, thickness of the insulator 7 should be thin as possible. The average particle sizes in the screen are between 1 and 15 μm, and the variation of the electric field E from the electrodes 5 and 6 over the particles is negligibly small as compared with the variation in the thickness of the insulator 7 (mm order). The polarized charges distribute at SV of the insulator 7. Therefore, the particles 14, rather than flat film, prefers for an increase in the accumulated SBC. The total surface area Sₜₒₜₐₗ of the particles arranged by one layer in defined screen area is given by πS≈3 times of S. The amount of the SBC increases by application of the particles. FIG. 9(B) schematically illustrates the enhancement of the SBCs (Xe¹⁺) on the insulator particle 14 placed on the insulator 7.

By referring the book of [Cathodoluminescence, Theory and Application, Kodansha Scientific, Japan, 1990], the total surface area of particles arranged in defined area is a function of the number of layers of particles, independent on particle sizes. Each of the insulator particle 14 on the insulator 7 forms a floating condenser, so that small particles (small volume) prefer as the insulator particle 14 for operation of FFL. The effective surface area of particles on the insulator particle 14 on defined area of the base plate glass 2 increases with the number of layers. Variation of E on particles in layers from the electrodes 5 and 6 is negligibly small compared with the variation in thickness of the insulator 7 (100 μm) in which the electrodes 5 and 6 are embedded. The inventors of the present invention only consider the number of layers of particles for reduction of Vₚ. The optimal number of layers of particles is determined from the adhesion of particles on substrate. In practical FFL, the particles should adhere on the glass plate with and without binder. Adhered particles on the insulator 7 are empirically determined as sizes in the range of 1 μm to 15 μm. The particles larger than 15 μm have large mass, and large particles in vacuum chamber fall out from the insulator 7 by a small mechanical shock, like as initial stage of vacuum pumping. The number of layers is determined by following conditions. Surface of particles should expose on Xe gas for formation of the SBC. The particle layers are determined by the maximum number for the surface area and by the minimum number for the capacitance. This is contradictory conditions. A compromise gives optimal number of the particle layers to be 2 to 8 layers. With the 3 layers of the particles, Sₜₒₜₐₗ is 9 times of S, and 15 times of S by 5 layers of the particles. Thus, by application of the insulator particles, the amount of the SBCs on the insulator 7 sharply increases with the number of layers of the particles, resulting in the remarkably lowering of Vₚ in the range of 3 kV. As already mention in the above, EP-A 0 363,832 discloses addition of MgO, Yb₂O₃, La₂O₃ and Ce₂O₃ as lowering materials of Vₚ of FFL, without specification of the particle sizes, number of layers of the particles, and physical properties of crystals. The inventors of the present is invention have found the utilization of the polarized charges in the insulator particles in the Xe chamber. This is different findings from the prior arts described above. The inventors of the present invention have found the usage of the polarized charges in the surface volume of the particles for the formation of the internal electric circuit. For the optimization of the operation of the internal electric circuits, the inventors of the present invention clearly define the nature of particles, and give optimal particle sizes and number of layers of the particles, based on the scientific characterization of the particles for optimization of the polarized charges. Those are the new findings.

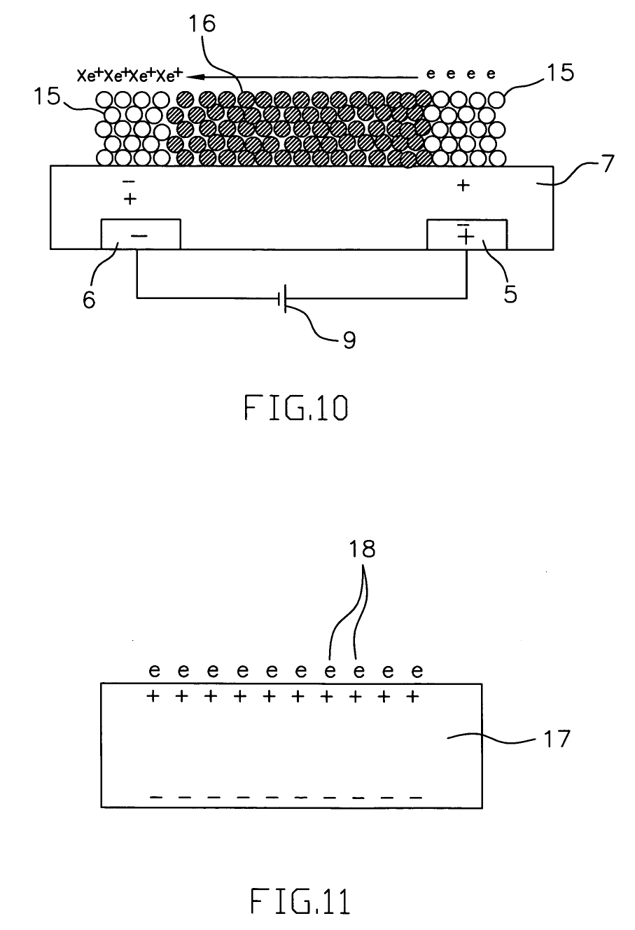

Further lowering of Vₚ can be achieved by application of the piezoelectric particles. The piezoelectric particles are center of asymmetry, which instantly deforms crystal figure by application of electric field. The crystals, which deform the figure, generate a large amount of the polarized charges. Typical piezoelectric particles are practical phosphor particles. According to the reference A, when the dopants that form luminescent centers occupy lattice sites of crystal having center of asymmetry, the forbidden transition of electrons in center symmetry (e.g., free ion) is lifted, and forbidden transition becomes allowed transitions in the asymmetric crystal,. Allowed transition probability is extremely high, compared with the transition in symmetry crystal. The practical phosphors require extremely high electron transitions for generation of luminescence in high intensity. Practical cathodoluminescent (CL) phosphor powders are produced with asymmetric crystal particles. CL phosphors are also produced with symmetric crystal particles with the dim CL that is not practical use. The inventors of the present invention have found that the ignition delay of the Xe discharge has been taken away from the FFL operation by application of the layered piezoelectric particles in asymmetric crystal on the insulator 7 which embed the electrodes 5 and 6. FIG. 10 schematically shows the five layers of the piezoelectric particles in asymmetric crystal 15 on the insulator 7, corresponding to the positions of the embedded the electrodes 5 and 6. The phosphor screen 16 is formed between the layers 15 of the piezoelectric particles. With the configuration in FIG. 10, Vₚ that applies to the electrodes 5 and 6 can remarkably reduce to the range of 1.5 kV. The Xe discharge in the Xe chamber starts by electron movement toward to Xe¹⁺. The phosphor screen 16 emits PL under irradiation of the VUV lights from the Xe discharge. However, the problems of a long ignition delay after storing in dark (hereinafter long ignition delay in dark) still remain in FFL operation. The ignition delay in dark does not allow the line scan of FFL as backlight for LCD. The mechanisms involved in the long ignition delay after dark (and in dark) differ from the mechanism of the ignition delay of the Xe discharge.

The inventors of the present invention have studied the long ignition delay in dark and after dark and have found the reasons of the problem. By application of E from the electrodes, the particles in the Xe chamber are instantly polarized and Xe in the Xe chamber are instantly ionized. Polarized charges in the surface volume of the piezoelectric asymmetric crystal particle attract and accumulate Xe¹⁺ and e⁻, respectively. The accumulated Xe¹⁺ and e⁻ tightly combine with polarized charges in SV of the particles in asymmetric crystal. Since the binding force of the charges are very strong, as already described, accumulated the SBC respectively stay on the surface of the individual particles with some distance, after removal of electric field of the electrodes. Especially, the piezoelectric particles in asymmetric crystal have the large amount of the SBC. FIG. 11 schematically illustrates SBE 18 on the piezoelectric particle in asymmetric crystal 17. For Xe discharge, electrons must extract from SBE which are strongly stuck on surface of the phosphor particles as far as SV holds holes. The formation of strongly stuck the SBC is the reason that FFL does not immediately ignite in dark.

The inventors of the present invention have solved the long ignition delay in dark by an application of a CL phosphor powder that has dopants in piezoelectric particles in asymmetric crystal. For taking away of the long ignition delay in dark from FFL operation, the powder of piezoelectric particles in asymmetric crystal 15, without dopant, is screened on the insulator 7 on the electrode which is applied negative V for tightly bound Xe¹⁺ in the Xe chamber. The CL phosphor particles 17, of which particles have clean surface, is screened on the insulator 7 that covers the electrode having positive V. For instance, the CL phosphor particles 17 is the low voltage ZnO that emits the bluish white CL. FIG. 12 illustrates the structure, which arranges layers of the piezoelectric particles in asymmetric crystal 15, and layers of piezoelectric CL phosphor particles 17, and phosphor screen 16 of FFL phosphors 16 between the asymmetric crystal and phosphor particles 17. The luminescent centers in the CL phosphor particles 17, even under piezoelectric stress, act as recombination centers of electrons and holes. The inventors of the present invention have found that the luminescent process in many phosphor particles is triggered by capture of an electron (and/or hole) by the luminescent center. The average distance (l) between the luminescent centers in the phosphor particle is given by average lattice distance (d) per concentrations of luminescence centers (c); e.g., l=d/c. The average lattice distance d is about 3×10⁻⁸ cm in many phosphor particles and concentrations of luminescent centers in practical CL phosphors for FFL are c>1×10⁻³ mole fraction. This gives the average distance of shorter than 0.3 μm (=3×10⁻⁸ cm/1×10⁻³) between luminescent centers. The SBE stays at 5 μm above the particles that is much far distance compared with 0.3 μm. Therefore, the captured electron (and/or hole) in luminescent center has the strong electric field (Eₑ) over the hole in SV, in the competition with the binding force (E_{SBE}) of SBE at outside of phosphor particle; Eₑ>>E_{SBE}. Consequently, the holes in surface volume in CL phosphor particles are attracted by the electric field of the electrons trapped in luminescent centers, and the holes in SV of the CL phosphor particles 17 move to luminescence center where recombine with electrons, releasing photons. Thus, the holes in SV of the CL phosphor particles 17 disappear from the particles. SBEs in front of CL phosphor particles lose binding counter partners, and SBEs become free electrons in the Xe chamber. The accumulated and strongly bound Xe¹⁺ charges smoothly attract the free electrons in the Xe chamber. The attracted electrons are accelerated by the positive field of Xe¹⁺ charges, generating Xe discharge in the Xe chamber. The problem of the long ignition delay in dark can be solved by application of the CL phosphor particles 17 on the insulator 7 as shown in FIG. 12. The structure, that uses AC particles for Xe¹⁺ accumulation shown in FIG. 12, is a best structure for operation of FFL. If one considers the production cost, there are possible to take other structures with an acceptable condition of operations of FFL.

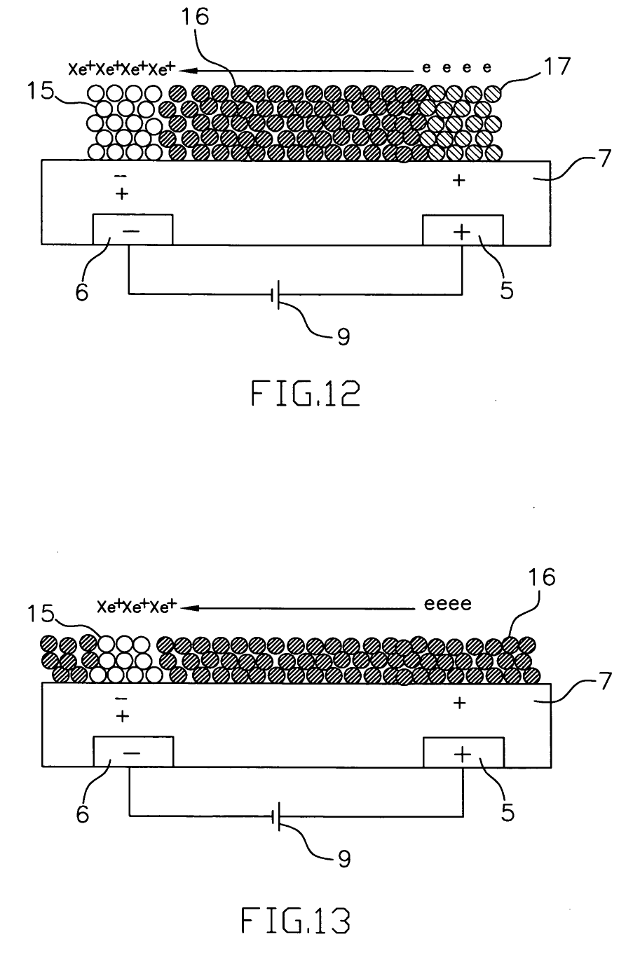

Here arises a problem that is the discharge path between the electrodes. The discharge path has a rainbow shape and irregular distribution of discharge density. Beside those, the discharge path fluctuates with time that is flickering, and the internal electric circuit has a large resistance, indicating that there are something else, which is not under control, in the Xe discharge path. For a reliable FFL, the discharge path should be straightened on the phosphor screen, by removal of obstructing items. The phosphors, which have been applied to the phosphor screens in FFL, are commercially available phosphor powders. They are BaMgAl₁₀O₁₇:Eu²⁺ blue, LaPO₄:Ce³⁺:Tb³⁺ green, Y₂SiO₅:Tb³⁺ green (Y,Gd)₂O₃:Eu³⁺ red, and Y₂O₃:Eu³⁺ red phosphors. By a careful study of the commercial phosphor powders, those phosphors are contaminated with the insulators, especially deliberately adhered microclusters of the insulators such as SiO₂, Al₂O₃, and so on, and the residuals of the by-products of the phosphor production. The phosphor screens are placed in the Xe chamber. Therefore, the insulator particles in the Xe chamber, even it is microclusters, are smoothly polarized by E from the electrodes, and the SBC instantly form on the surface of the polarized insulators. The SBC on the insulators electrically shield the phosphor particles in the phosphor screens. The moving electrons in the Xe chamber are obstructed by the electric fields of the SBC on the insulators. The efficient CL phosphor particles are made by the good piezoelectric particles in asymmetric crystal. The phosphor screen 16 is prepared on entire area of the insulator 7 by the efficient CL phosphor powder which emits PL under the VUV lights, except for the Xe¹⁺ accumulation area which is covered by the particles the asymmetric crystal 15 without luminescent centers, as illustrated in FIG. 13. The SBEs on the surface of the CL phosphor particles in the phosphor screen 16, which are instantly formed by the application of E of the electrodes 5 and 6, become the new supplier of free electrons after the emission of the CL phosphor particles. A huge amount of free electrons exists in front of the phosphor screen. The positive field by the accumulated Xe¹⁺ charges on the particles in asymmetric crystal 15 easily attracts the electrons from everywhere in front of the CL phosphor screen 16. There is no obstructing material in the moving electrons, except for the impact collision with Xe. This gives a minimum resistance of the internal electric circuit. As the consequence, the discharge path on the phosphor screen 16 is straightened without flicker of the discharge path.

Furthermore, maintaining Vₘ is a low, and a most significant practical effort is increases in PL output from the phosphor screens by the narrow gap between the discharge path and the phosphor screens, and by a wide discharge path with uniform density. The preferred commercial CL phosphor powders, which the particles have clean surface, are the low voltage CL phosphors. They are bluish white emitting ZnO phosphor, and blue emitting ZnS;Ag:Cl and green emitting ZnS:Cu:Al, and (Zn,Cd)S:Cu:Al red phosphors without In₂O₃ microclusters, and Zn₂SiO₄:Mn phosphor. The inventors of the present invention have also found that as the phosphor screen 16 is made by a mechanical mixture of a low voltage CL phosphor listed above and the commercial phosphor powders, like as BAM, LAP and others, the phosphor screen 16 has the similar effort for reduction in the resistance of electron flow, even as the mixture of the phosphor powder contains more than 10 wt % of the low voltage CL phosphor powder.

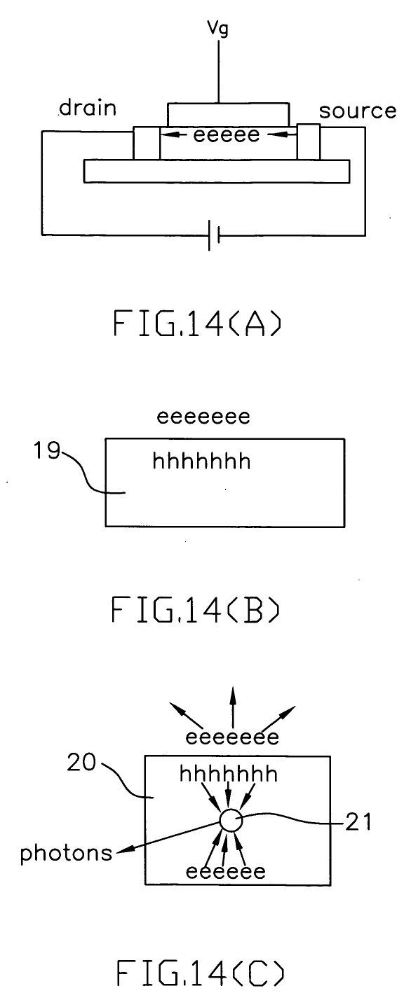

The inventors of the present invention have clarified the indistinctness of the surface conduction mechanism of electrons, after extensive study of microelectronics of solid state materials of which the results have been published in Materials, Chemistry and physics, Vol. 60, pp 274-281, 1999. The surface conductance of electrons is not related with the ratio of the secondary emission from materials which have traditionally been considered, but the surface conduction is related with mobility of SBEs, which are controlled by presence of holes in surface volume of the phosphor particles, as already described. It is well known that thin film transistor (TFT) is operated by control of mobility of SBEs. Mobility of SBEs is controlled by gate voltage V_{g} as illustrated in FIG. 14(A). It is known that SBE has anisotropic mobility; the mobility to parallel direction on the surface is higher than the mobility to perpendicular direction. TFT utilizes anisotropic mobility. As positive V_{g} is applied to gate electrode, electrons in surface volume of Si wafer are attracted to gate potential to forming SBEs, giving rise to high resistance for electron mobility. When negative V_{g} is applied to gate electrode, the electrons are not attracted by gate electrode, and mobility of electrons is very high (low resistance). Then, electrons flow from source to drain electrodes. The mobility of SBEs on insulator in FFL is analogous with TFT operation. Mobility of SBEs on insulator is controlled by presence of holes (gate in TFT) in surface volume of crystal. In the case of insulators 19, SBEs stay in front of the insulator 19 by the presence of holes in surface volume, FIG. 14(B). As already described, SBEs are free carriers on CL phosphor particles 20, FIG. 14(C), where holes in surface volume disappear by the recombination at the luminescent centers. The free electrons are anisotropic mobility on the phosphor screen, accumulated Xe¹⁺ is drain and accumulated e⁻ is source in TFT. Therefore, as far as the phosphor screen is prepared with practical low voltage CL phosphors, the electrons move from everywhere on the low voltage CL phosphor screen, and the electrons move on in front of surface of CL phosphor screen, about 5 μm above, toward to accumulated Xe¹⁺. The resistance 13 in FIG. 6(B) for electron movement on phosphor screen is by collision of accelerated electrons with Xe gases. As the results that the electrons have anisotropic mobility, maintaining voltage Vₘ is remarkably lowered to the range of several hundred volts. The low maintaining voltage Vₘ favors for the small driving device.

The inventors of the present invention have found a more advance technology that all problems of high ignition voltage Vₚ, long ignition delay after dark and in dark, and high maintaining voltage Vₘ are solved as entire area of the inner surface of the insulator 7 on the basic plate 2, and the top plate 3 of FFL are covered by the CL phosphor particles, especially, CL phosphor powders having the triboluminescence. FIG. 15 shows the phosphor screen 19 on the insulator 7. The positive field by Xe¹⁺ charges, either monopole or bipolar operation, attracts the electrons from everywhere in front of the CL phosphor screen 19, giving rise to the high output of the PL from the phosphor screen 19. The high voltage for ignition is generated by the triboluminescent CL phosphor particles, and the polarized charges in the CL phosphor particles disappear by the generation of the luminescence. By use of the triboluminescent CL phosphors, SBCs are immediately free after ignition of the discharge. This gives the low Vₚ as well as instant discharge in dark and low Vₘ with the emitted luminescence. The preferable triboluminescent CL phosphor powders are ZnS;Ag:Cl, ZnS:Cu:Al, ZnS:Mn, ZnS;Mn:Pb, self-activated ZnO, and Zn₂SiO₄:Mn of which the particles have clean surface.

The inventors of the present invention like to clarify criterion and confusion of kinds of the phosphors. Some PL phosphor powders may solve the problems of Vₚ, Vₘ, and ignition delay in dark, but other PL phosphors do not solve the problem even with the clean surface. By referring of reference A, luminescent centers in the phosphor particles are excited by two ways with the UV lights; direct excitation by incident UV lights, and indirect excitation via mobile carriers which are generated in the phosphor particles. Luminescent centers of PL phosphors for FL are directly excited by the incident lights of the 254 nm Hg lines. If luminescence centers are only excited by the 254 nm Hg line, those phosphors do not solve problems of Vₚ, Vₘ, and ignition delay in dark. The PL phosphors which have PL emission under irradiation of host lattice excitation can solve problems of Vₚ, Vₘ, and ignition delay in dark. Under host lattice excitation, electrons in valence band move to conduction band, leaving holes in valence band. Electrons in conduction band and holes in valence band are mobile carriers. Mobile electrons and holes move toward to luminescent centers and then recombine at recombination centers. Those phosphors are also brighter phosphors under irradiation of electrons. The criterion of selection of the phosphors and surely capable phosphors are practical low voltage CL phosphor powders. Many commercial phosphor powders do not emit the brilliant PL with the surface contaminations which absorb the incident VUV lights before reaching to phosphor particles.

FFL utilizes PL that is generated by conversion of the VUV lights from Xe discharge to visible lights. The phosphor screen merely transduce the VUV lights to the visible lights. According to the reference A, the energy conversion efficiencies of the practical phosphors have been optimized practically and theoretically for 30 years ago. We can not expect increase of PL output from the phosphor screen as far as the phosphor screens are properly prepared. In many cases, the commercial phosphor particles are heavily contaminated with impurities which are deliberately adhered on surface; that is surface treatment. When the phosphor screen is prepared with the phosphor powders without contamination, output of PL in FFL is linear with irradiated VUV light intensities in quite wide range. PL intensities increase 5 times with 5 times of irradiated VUV intensity at present level. This means that improvement of PL brightness of FFL is only obtained by increase of the VUV intensities on the phosphor screen, remaining the constant of the energy conversion efficiency of the phosphors. The VUV intensities in Xe discharge increases with the high pressure of Xe gas in the vacuum chamber. At a given discharge condition, self-absorption is commonly overlooked in discussion of PL intensities of FFL. The emitted VUV lights are generated by electronic transitions from excited levels to ground state of Xe. If there is a distance between Xe discharge path and the phosphor screen, Xe gases in the gap absorb the VUV lights emitted in discharge, i.e., self-absorption. FFL is usually produced with high pressure of Xe gas, e.g., 500 torr. The discharge path on the phosphor screen form the rainbow shape that discharge path at center departs from the phosphor screen. There are many unexcited Xe gas in the gap. Therefore, PL output increases as the discharge path is straightened and the gap between discharge path and the phosphor screen is narrowed. As far as the phosphor screens are made by the commercial BAM, LAP, and YBO₃ phosphors, that are not CL phosphors, the phosphor particles surely have SBEs. Moving electrons receive repulsion from negative charges of SBEs, and moving electrons disappear from the Xe chamber as electrons meet Xe⁺ on the phosphor screen. Disturbance of the electron flow path by the SBEs gives rise to flickering Xe discharge, rainbow shape discharge path, and brighter fringes with large dark center area in the discharge. As the phosphor screen is made by the CL phosphors for VFD application, e.g., bluish white emitting ZnO phosphor, Xe discharge path is straightened at 5 μm above the phosphor screen, with uniform density of the discharge, giving rise to the large amount of the VUV lights on the phosphor screen. This results in an enhancement of PL output from the phosphor screen. ZnO phosphor screen in FFL indeed emits a high PL luminance without flickers as compared with the phosphor screens by the BAM, LAP, and other phosphors. Some blue ZnS:Ag and green ZnS:Cu:Al of the VFD phosphors, without adhesion of In₂O₃ microclusters, are also used as the phosphor screen of FFL.

The inventors of the present invention will discuss optimization of the structure of the phosphor screens in FFL. The phosphor screen is produced by arrangement of the phosphor particles.

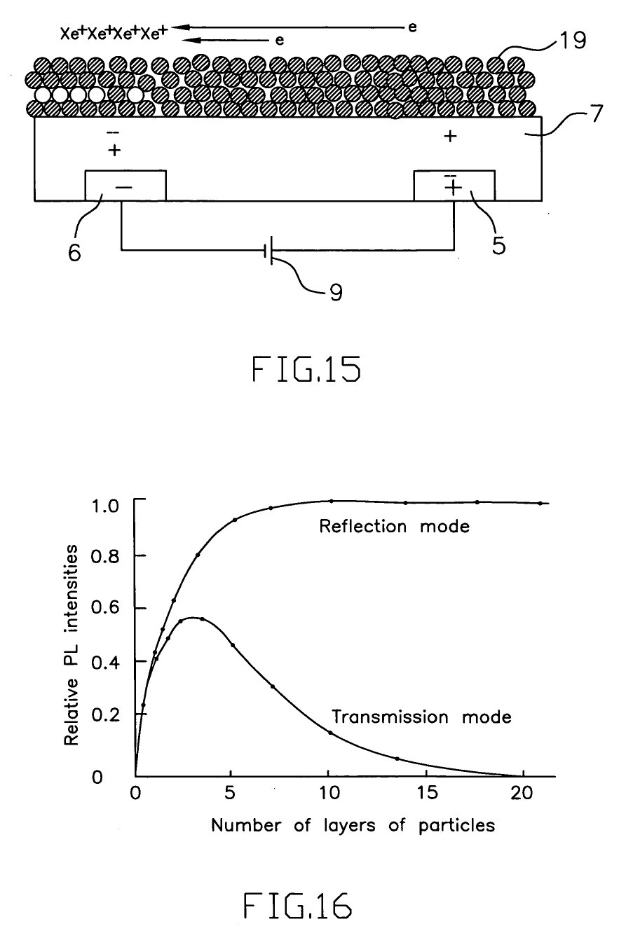

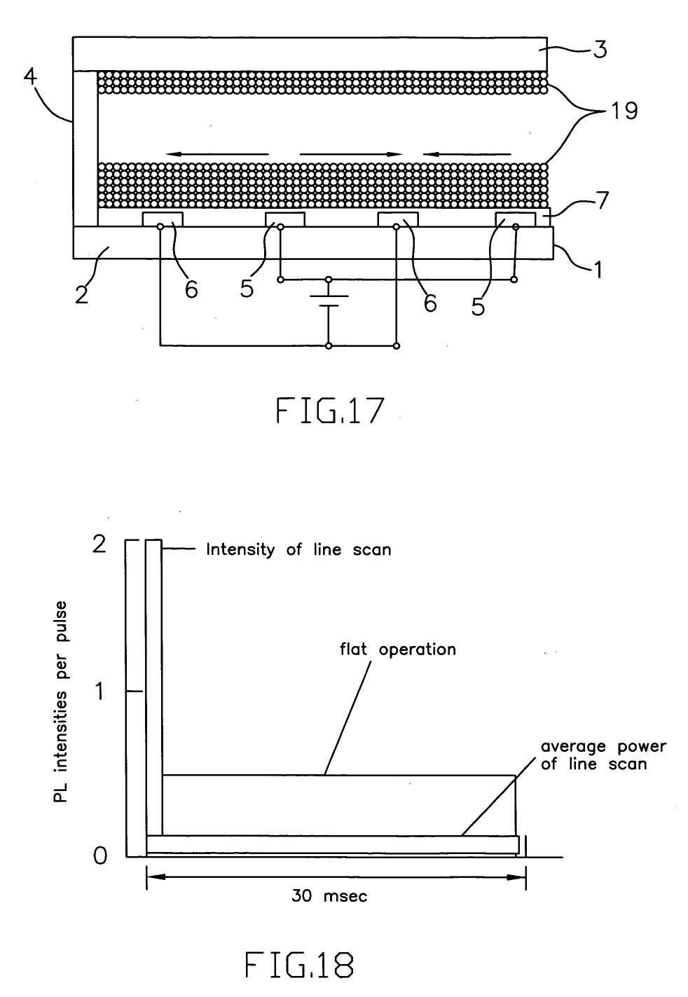

The practical phosphor particles have the large coefficient of reflection. About 60% of irradiated VUV lights reflect on surface of the phosphor particles arranged at top layer of the phosphor screen, and residual 40% penetrates in exposed the phosphor particles in screen, generating PL. If the phosphor screen has gaps between the particles, the reflected VUV lights may get in gaps. The VUV lights get in the gaps have a chance to penetrate in to other phosphor particles laid down in deep layers of the phosphor screen. The VUV lights in the gap are also reflected on surface of other phosphor particles laid down in deep layer from surface. There is an optimal number of layers of the phosphor particles for FFL. The inventors of the present invention have extensively studied on the optimal number of layers for generation of PL. FIG. 16 shows the measurement results. If the PL intensities are detected at exposure side (i.e. reflection mode), the optimal number of screen layers is average 7 layers. The output of PL is saturated with the screens thicker than 8 layers. When the PL intensities are measured with PL that has passed though the phosphor screen (i.e., transmission mode), the optimal screen is made by average 3 layers of the particles. As already mentioned, the phosphor screen forms a good reflection of emitted PL. The phosphor screen has a good light reflection layer. As far as the phosphor screen in reflection mode is made by the optimal screen layers (7 layers), additional reflection layer by Al₂O₃ powder underneath the phosphor screen, like as disclosed in U.S. Pat. No. 6,034,470, is not necessary. PL detection of the phosphor screen on the basic plate glass is reflection mode, so that the phosphor screen 19 should be made with 6 layers of the particles on the basic plate glass. PL detection of the phosphor screen on the top plate glass is made by transmission mode, and the phosphor screen 20 should be made with 3 layers of the particles on surface top plate glass. FIG. 17 illustrates the preferable phosphor screens 19 in practical FFL. The phosphor particles do not have absorption band in the visible spectrum wavelengths. PL output from FFL is given by conjugation of emitted PL of the phosphor screens on the basic and top plates of the vacuum vessel, and observed PL luminance is linear with emitting area of the phosphor screen. Consequently, the PL from optimized phosphor screens gives a high luminance, and detected PL lights are well scattered by the phosphor particles. Therefore, light output from invented FFL is equivalent with scattered lights in daytime. The invented FFL can be used as backlight of LCD as well as illumination source of rooms of house and outdoor activity.

The inventors of the present invention have considered about power consumption of operation of FFL without sacrifice of PL output. The inventors of the present invention have found that power consumption of the invented FFL significantly reduce in operation of FFL with quick start of the Xe discharge. The human brain recognizes lights after retina has averaged out received light intensities with time for the effort of after-images that is 30 msec. Therefore, when the narrow horizontal lines of FFL electrodes vertically scan from top to bottom with in 30 msec, the total FFL area is scanned by one line. The power consumption is given by time average of one scanning line. If number of scanning lines are 300 lines, the time of one scanning line is calculated as 1/(30×300) sec≈ 1/10,000 sec=0.1 msec, and the power consumption of total FFL is only the power of one scanning line, so that the power consumption is 1/300 of the frame scan. FIG. 18 schematically illustrates the power saving. The invented FFL allows the line scan. Here is another great advantage of FFL as backlight of LCD. By line scan, the black level becomes a real black, like as the charcoal black, giving rise to the clear images by the really high contrast ratio from the real black. Another advantage is that the response time of the images on LCD screen is actually determined by the backlight response time, independent of the response time of LC layer. And the response time of the invented FFL is a few msec. This gives sharp images on LCD screen without smear of rapid moving images. Furthermore, operation of FFL with high luminance with low power consumption is a great advantage as illumination source, and the present invention contributes to improvement of living standard of human activity.

What is claimed is:

1. A mercury-free flat fluorescent lamp, comprising;
a driving electric circuit on a base plate glass and an internal electric circuit formed in a Xe gas chamber, wherein said driving electric circuit and said internal electric circuit are isolated in electron flow, and a phosphor screen coated on an inner wall of said gas chamber.

2. The lamp according to claim 1, wherein said internal electric circuit comprising Xe gas and luminescent particles in said gas chamber.

3. The lamp according to claim 1, wherein said internal electric circuit includes a power source formed by the electric charges of ionized gas, which bind with the polarized charges that are induced in surface volume of said luminescent particles by an electric field from said driving electric circuit.

4. The lamp according to claim 1, wherein said internal electric circuit further includes a switch operated by moving of an electron liberated from a surface of said luminescent particle to accumulated positive charges on said luminescent particles.

5. The lamp according to claim 1, wherein said internal electric circuit further includes a resistance formed by obstruction of moving electron path by repulsion with charges in same polarity, and by collision with Xe gas in said gas chamber.

6. The lamp according to claim 1, wherein a Xe gas in said Xe gas chamber emits ultraviolet light by discharge.

7. The lamp according to claim 1, wherein luminescent particles form the phosphor screen in said Xe gas chamber and the phosphor screen emits the lights in the visible spectral wavelengths under irradiation of ultraviolet lights.

8. The lamp according to claim 1, wherein said mercury-free fluorescent lamp is used as backlight of liquid crystal display (LCD).

9. The lamp according to claim 8, wherein said mercury-free fluorescent lamp as backlight is operated by line scan mode.

10. The lamp according to claim 1, wherein said mercury-free fluorescent lamp is used as illumination source.
